(19) United States
(12) Patent Application Publication
(10) Pub. No.: US 2005/0013550 A1
(43) Pub. Date: Jan. 20, 2005

(54) Clip disk for grinding optical fibers

(76) Inventor: Chen-Hung Hung, Chia-Yi Hsien (TW)

Correspondence Address: TROXELL LAW OFFICE, PLLC, Suite 1404, 5205 Leesburg Pike, Falls Church, VA, 22041, US

(21) Appl. No.: 10/619,469

(22) Filed: Jul. 16, 2003

(51) Int. Cl. G02B 6/36

(52) U.S. Cl. 385/85

(57) ABSTRACT

A clip disk for grinding optical fibers comprises a round disk body and a handle firmly secured to the disk body. A plurality of disk grooves are installed on the disk body for receiving a core of a joint of an optical fiber. A plurality of clips are installed on the disk body; each clip including a supporting seat and a movable piece connected to the supporting seat and capable of rotating. The supporting seat is formed with an opening for receiving a joint of an optical fiber. The cores of optical fiber joints inserting into the disk grooves of the disk body and a part of each core protruding out of the disk groove. When a force is applied to one end of the movable piece; another end of the movable piece will move upwards for receiving and fixing the optical fiber joints.

### FIELD OF THE INVENTION

The present invention relates to clip disk for grinding optical fibers; and particularly to a clip disk for grinding optical fibers where a round disk is installed with a plurality of fixtures for clamping optical fiber joints rapidly and thus it can grind the cores of the optical fibers.

### BACKGROUND OF THE INVENTION

Referring to FIG. 1A, the current used grinder 10 is illustrated. The grinder 10 has a machine seat 11. A driver is installed in the machine seat 11. The driver can be connected to a grinding disk 12 so that the grinding disk 12 can move circumferentially. A rubber pad 13 is fixed to the grinding disk 12. A grinding paper is combined with the rubber pad 13 for grinding a core of an optical fiber. A base 14 is fixed above the machine seat 11. A slidable supporting seat 15 is connected to the machine seat and is controlled by a hook 16 so that the supporting seat 15 moves closely or separates from the grinding paper. A grinding clip disk 17 is combined to one end of the supporting seat 15. A plurality of optical fiber joints are disposed thereon. The grinding clip disk 17 is controlled by the supporting seat 15 so as to control the relation with respect to the grinding paper.

Referring to FIG. 1B, the grinding clip disk 17 has a sheet-like disk body 18 and a handle 19 is combined to the disk body 18. An edge of the disk body 18 has eight lateral sides 111. Each lateral side 111 has a plurality of V shape grooves 112 for placing cores of an optical fiber joint 115. Each lateral side 111 is installed with a fixture 113 and plurality of screws 114 are used to connect the disk body 18 so that the a core of an optical fiber can be fixed to the V shape groove 112. Thereby, the end portion of the core can be grounded.

However when inserting the optical fiber joint 115, in the clip disk 17, each screw 114 must be loosed 114 for inserting the optical fiber core into the V shape groove 112. When the optical fiber core has been inserted, then the screws 114 are screwed so that the core is fixed to the clip disk 17. If the grinding operation is complete, a reverse operation is performed for taking out the optical fiber joint 115. Above mentioned operation is tedious and inconvenient and thus the cost is high and efficiency is low.

### SUMMARY OF THE INVENTION

Accordingly, the primary object of the present invention is to provide a clip disk for grinding optical fibers which comprises a round disk body and a handle firmly secured to the disk body. A plurality of disk grooves are installed on the disk body for receiving a core of a joint of an optical fiber. A plurality of clips are installed on the disk body; each clip including a supporting seat and a movable piece connected to the supporting seat and capable of rotating. The supporting seat is formed with an opening for receiving a joint of an optical fiber. The cores of optical fiber joints insert into the disk grooves of the disk body and a part of each core protrudes out of the disk groove. When a force is applied to one end of the movable piece, another end of the movable piece will move upwards for receiving and fixing the optical fiber joints.

The various objects and advantages of the present invention will be more readily understood from the following detailed description when read in conjunction with the appended drawing.

### BRIEF DESCRIPTION OF THE DRAWINGS

FIG. 1A is a perspective view of a prior art clip disk for grinding optical fibers.

FIG. 1B is a perspective view showing that a prior art clip disk for grinding optical fibers is assembled to a grinding machine.

FIG. 2 is a perspective view of the clip disk for grinding optical fibers of the present invention.

FIG. 3 is a cross section view showing that the present invention is at a close state.

FIG. 4 is a cross section view showing that the present invention is at an open state.

FIG. 5 is a perspective view showing that the clip disk for grinding optical fibers of the present invention is fixed with an optical fiber joint; and

FIG. 6 is a cross section view showing that the clip disk for grinding optical fibers of the present invention is clamped with an optical fiber joint.

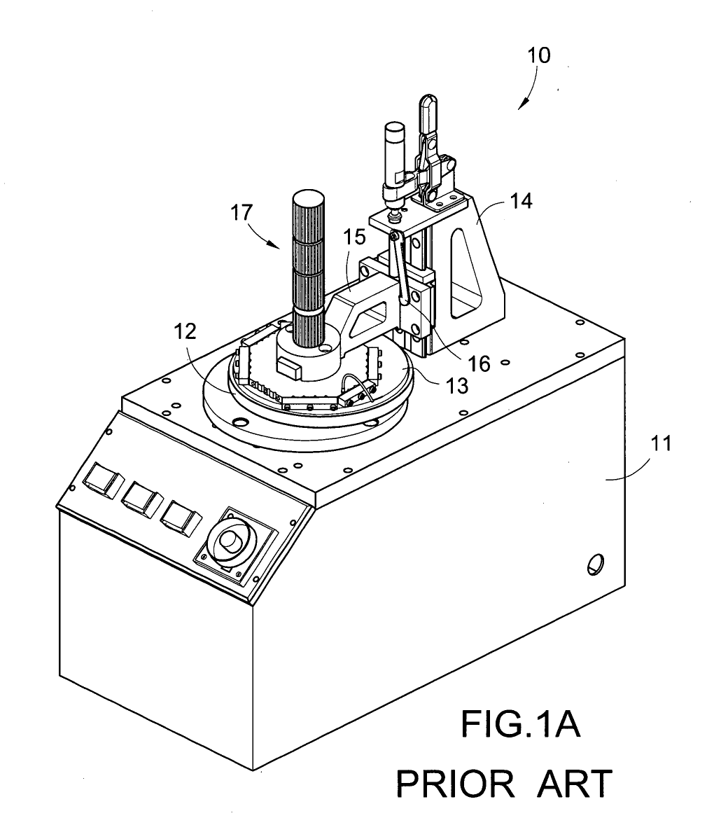

### DETAILED DESCRIPTION OF THE PREFERRED EMBODIMENTS

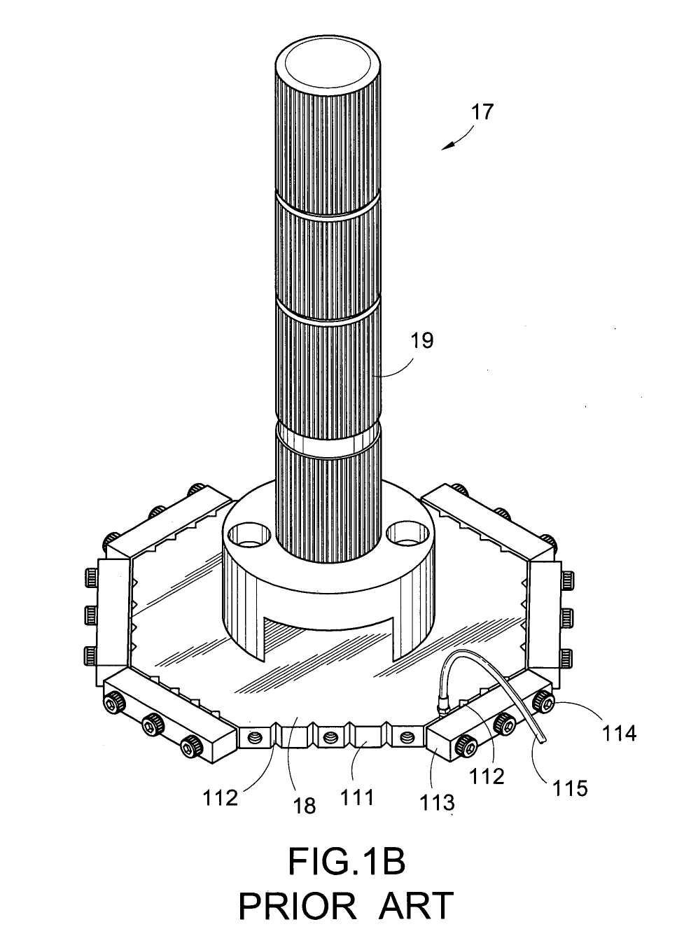

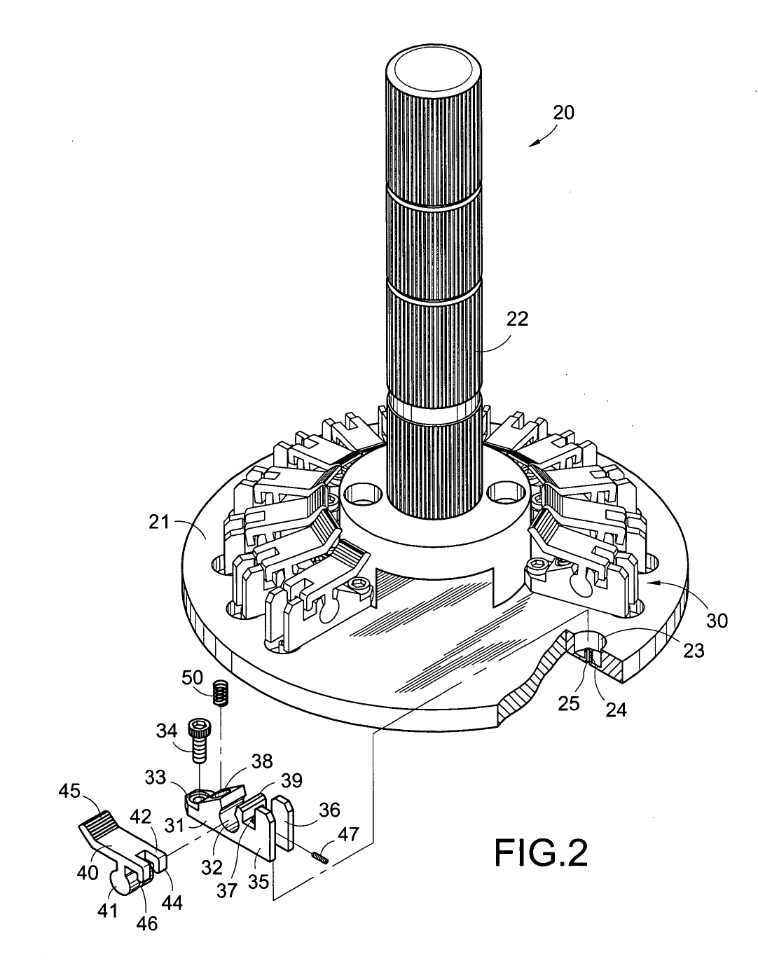

Referring to FIGS. 2 and 3, the clip disk for grinding optical fibers 20 of the present invention includes a round disk body 21, and a handle 22 which is firmly secured to the disk body 21. A plurality of disk grooves 23 are installed on the disk body 21. Each disk groove 23 has an equal distance to a center of the disk body 21. Each disk groove 23 has been located with a post 24. Each post 24 has a recess 25 for receiving a core of a joint of an optical fiber.

A plurality of clips 30 are installed on the disk body 21. The clips 30 are arranged around a handle 22. Each clip 30 includes a supporting seat 31. A round slot 32 is installed on the supporting seat 31 for receiving a cylindrical rotating means 41 of a movable piece 40 so that the movable piece 40 rotates around the rotating means 41. A supporting body 33 of the supporting seat 31 is firmly secured to the disk body 21. The supporting body 33 is installed at one end of the supporting seat 31. The supporting body 33 is combined to the disk body 21 by a screw 34. One end 35 of the supporting seat 31 is formed with an axial stepped opening 36 which is communicable to the groove 23 for receiving a joint of an optical fiber.

An opened recess 37 is formed between the stepped opening 36 and the receiving groove 32. The opened recess 37 is communicable to the stepped opening 36 to be axially spaced with the receiving groove 32. A locating groove 38 is formed between the receiving groove 32 and the supporting end 33. An spring 50 is located in the locating groove 38. One end of the spring 50 is received in the hole 43 of the movable piece 40. A top end of the locating groove 38 has an inclined plane for controlling the maximum rotating angle as the movable piece 40 is pressed.

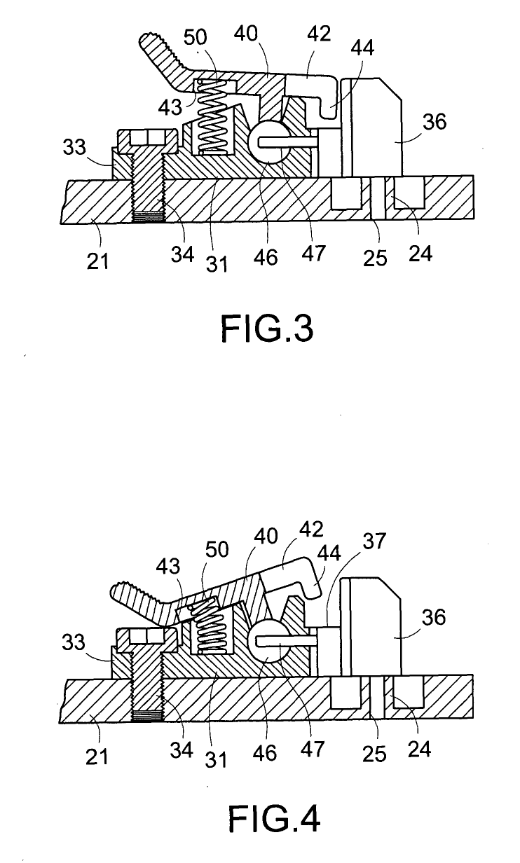

A front end of the movable piece 40 has a biforked arm 42. Each end of the biforked arm 42 has a rib 44. The rib 44 is placed in the opened recess 37. A lower side of the biforked arm 42 is in contact with an upper end of the control piece 39. The control piece 39 is between the receiving groove 32 and the opened recess 37 for controlling the insertion depth of the rib 44 in the opened recess 37. The movable piece 40 can rotate through an angle in the receiving groove 32 by using the rotating means 41 as a fulcrum so that the ribs 44 move upwards and downwards in the opened recess 37 so as to move from a close position shown in FIG. 3 to an open position shown in FIG. 4.

The rotating means 41 is installed with an axial penetrating hole 46. A screw 47 inserts into the stepped opening 36 to the penetrating hole 46 for preventing the forward and backward movement of the rotating means 41 in the receiving groove 32.

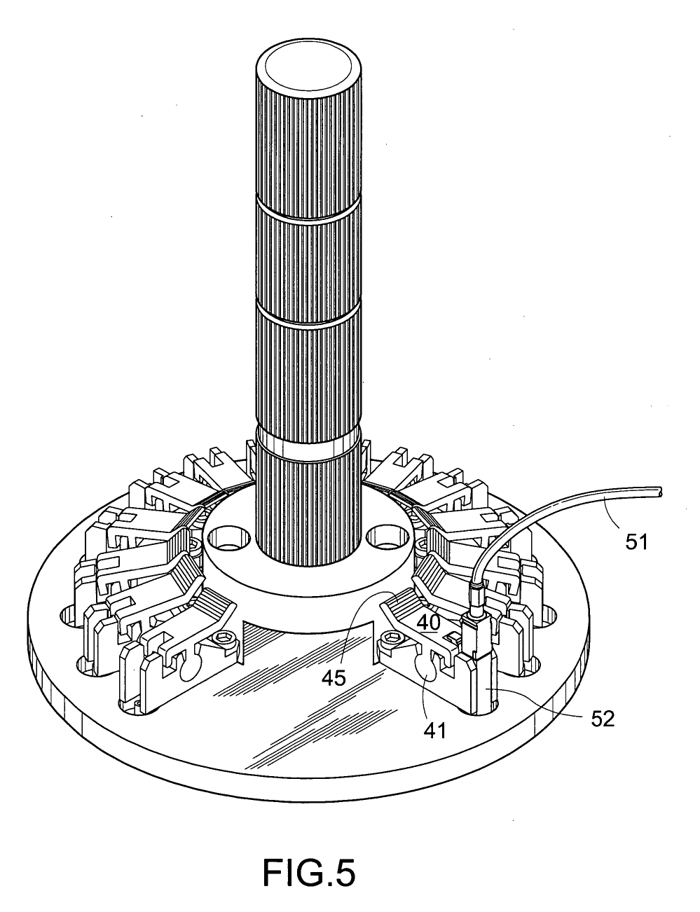

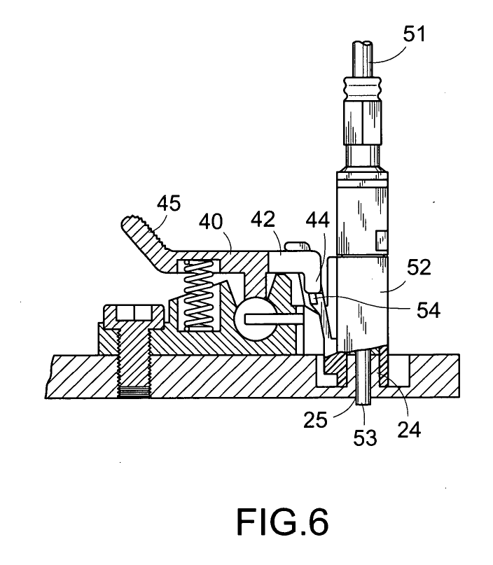

With reference to FIGS. 5 and 6, a press portion 45 installed at one end of the movable piece 40 to extend outwards. When the movable piece 40 presses the press portion 45 at a close position (see FIG. 3) of the rotating means 41 (at this time, the extension spring 50 is at a compressing state), the biforked arm 42 moves upwards along the rotating means 41 and the ribs 44 move upwards with the bifroked arm 42. Then the movable piece 40 is opened so that a larger insertion space is formed between the ribs 44 and the opened recess 37. Thereby, the joint body 52 of the optical fiber joint 51 is inserted into the recess 37 and is fixed to the recess 25 of the post 24 and an end portion of the core 53 of the optical fiber protrudes out of the recess 53 with a predetermined length.

Then the force applied to the press portion 45 can be released. The press portion 45 ejects one end of the movable piece 40 by the elastic force thereof, and ribs 44 at another end of the movable piece 40 will move downwards. Then the ribs 44 are positioned above the wing 54 of the joint body 52 for confining the joint 51 from moving upwards to leave the clip assembly 30. Thereby, by the clip disk for grinding optical fibers of the present invention, a plurality of optical fiber joints 50 can be assembled to the clip assembly 30 for grinding cores of the optical fibers. After grinding, a reverse operation is performed for taking out the optical fibers.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A clip disk for grinding optical fibers comprising a round disk body and a handle firmly secured to the disk body; a plurality of disk grooves being installed on the disk body for receiving a core of a joint of an optical fiber; characterized in that:
a plurality of clips being installed on the disk body; each clip including
a supporting seat being formed with an opening for receiving a joint of an optical fiber; the cores of optical fiber joints inserting into the disk grooves of the disk body and a part of each core protruding out of the disk groove; and
a rotatable movable piece connected to the supporting seat; one end of the movable piece serving to close the opening; wherein when a force is applied to one end of the movable piece; another end of the movable piece will move upwards for receiving the optical fiber joints therein and when the force applied to the movable piece is released, the optical fiber joint is fixed in the opening.

2. The clip disk for grinding optical fibers as claimed in claim 1, wherein the movable piece has an elastic means for being secured to the supporting seat.

3. The clip disk for grinding optical fibers as claimed in claim 1, wherein the supporting seat has a receiving groove for receiving a rotating means of the movable piece so that the movable piece will move around the rotating means and thus the movable piece rotates in the receiving groove of the supporting seat.

4. The clip disk for grinding optical fibers as claimed in claim 1, wherein the supporting seat has a control piece for controlling the length of downward movement of one end of the movable piece.
